(19) United States
(12) Patent Application Publication
(10) Pub. No.: US 2005/0116584 A1
(43) Pub. Date: Jun. 2, 2005

(54) Electronic switch and method of use for actuating a door

(75) Inventor: Vladimir Federman, Winnipeg (CA)

Correspondence Address: ADE & COMPANY, 1700-360 MAIN STREET, WINNIPEG, MB, R3C3Z3, CA

(73) Assignee: Integrated Door Controls Division of 4395591 Manitoba Ltd.

(21) Appl. No.: 10/964,679

(22) Filed: Oct. 15, 2004

(30) Foreign Application Priority Data
Nov. 27, 2003 (CA) 2,451,283

(51) Int. Cl. H01H 9/28

(52) U.S. Cl. 310/339

(57) ABSTRACT

An electronic switch is provides in which pressure applied to a pressure transducer acts to close a pair of power transistors. The transistors each include a gate terminal in the form of a capacitor so that no external powering of the switch components is required, only potential generated by the transducer. The drain and source terminals of the transistors are connected in anti-serial configuration between the switch connections of the switch. A suitable housing includes a mounting plate to be secured to a wall and a moveable cover plate which is supported on the mounting plate for locating the electronic components therebetween. Access to slots receiving the cover plate therein is blocked when the mounting plate is secured to a supporting surface to prevent subsequent removal of the cover plate from the mounting plate.

### FIELD OF THE INVENTION

The present invention relates to an electronic switch using a pressure transducer for actuation thereof, and more particularly relates to a method of using an electronic switch for actuating a door.

### BACKGROUND

Due to the material wear resulting in limited number of on and off cycles typically associated with mechanical switches, the use of electronic switching circuits and electronic switches are known to be desirable for their extended life. U.S. Pat. Nos. 5,231,326 to Echols and U.S. Pat. No. 5,170,087 to Karr disclose examples of switches including pressure transducers in a switch in which minimal wear of the components results. A complex circuitry is required in each instance however as the signal from the pressure transducer is required to be fed to a transistor amplifier requiring a power supply for powering related switching circuitry. The resulting circuitry is complex and costly to manufacture and implement.

In one example of an application for a switch, wall mounted switches are known for actuating powered doors for access in various public buildings and the like for disabled persons. The switches in this instance are often subjected to considerable abuse due to their public environment and accordingly a switch involving minimal wear is desired. Known switches for this application however typically require mechanical components or complex circuitry in order to actuate opening of the door. Vandalising of the complex components of the switch results in further cost for maintenance of such known designs of switches.

### SUMMARY

According to one aspect of the present invention there is provided a switch comprising:
a pair of switch terminals;
a transistor having a drain terminal and a source terminal connecting the transistor in series between the switch terminals whereby current flow is permitted between the switch terminals when the transistor is closed;
a housing having a movable contact area; and
a pressure transducer located within the housing in communication with the contact area;
the transistor including a gate terminal connected to the pressure transducer to close the transistor when pressure is applied to the pressure transducer.

The direct connection of the transducer to the gate of the transistor and providing that the transistor is directly coupled in series with the switch terminals provides a simple construction which can be readily manufactured and in which the switching components do not require external power for operation thereof. The voltage difference provided by the pressure transducer is sufficient to operate the transistor when coupled in the above configuration.

According to a second aspect of the present invention there is provided a switch comprising:
a pair of switch terminals;
a transistor having a drain terminal and a source terminal connecting the transistor between the switch terminals whereby current flow is permitted between the switch terminals when the transistor is closed;
a housing including a mounting plate for mounting on a suitable supporting surface and a cover plate supported on the mounting plate for relative movement therebetween; and
a pressure transducer located between the mounting plate and the cover plate of the housing;
the transistor including a gate terminal connected to the pressure transducer to close the transistor when pressure is applied to the pressure transducer; the cover plate including a plurality of retainer members selectively received in co-operating slots in the mounting plate, accessible through a rear of the mounting plate such that access to the slots is blocked to retain the cover plate on the mounting plate when the mounting plate is mounted on a supporting surface.

The arrangement of a housing in which a cover plate is provided for concealing electronic components of the switch and in which access to remove the cover is restricted once the mounting plate is in a secure mounted position, minimizes the opportunity for vandalising or excessive wear of the components of the switch.

According to a further aspect of the present invention there is provided a method of actuating an automatic door, the method comprising:
providing a door actuator to open the door responsive to condition of a door switching circuit;
providing a door switch comprising a pressure transducer and a transistor having a drain terminal, a source terminal and a gate terminal connected to the pressure transducer;
connecting the drain terminal and the source terminal in series with the door switching circuit; and
applying pressure to the pressure transducer to close the transistor and actuate the door actuator via the door switching circuit.

The transistor in each instance preferably comprises a TMOS power transistor in which the gate terminal comprises a capacitor. Accordingly there may be provided a bleed-off resistor coupled to the gate terminal to prevent erroneous charges accumulating on the gate.

When the transistors comprise TMOS power transistors, preferably a pair of the transistors connected at respective source and drain terminals in an anti-serial configuration with the switch terminals for proper operation in alternating current applications.

There may be provided a pair of voltage limiting diodes coupled together in an opposed configuration in parallel with the pair of transistors between the switch terminals to limit maximum voltage applied across the transistors.

A voltage limiting diode is preferably coupled between the gate terminal and the source terminal of the transistors to limit maximum voltage applied to the gate terminal.

The housing may include a mounting plate for mounting on a suitable supporting surface in which the movable contact area comprises a cover plate supported on the mounting plate for relative movement therebetween. A stop or limit may be formed on the housing to limit maximum deflection of the cover plate relative to the mounting plate.

When the mounting plate includes mounting apertures formed therein for receiving fasteners to mount the mounting plate to a supporting surface, the cover plate preferably conceals the mounting apertures when supported on the mounting plate.

The cover plate may include a plurality of retainer members selectively received in co-operating slots in the mounting plate accessible through a rear of the mounting plate such that access to the slots is blocked to retain the cover plate on the mounting plate when the mounting plate is mounted on a supporting surface.

The retainer members preferably each comprise a hook having a free end portion which is flat lying generally parallel to a front surface of the cover plate for ease of sliding behind the mounting plate during assembly.

The retainer members preferably comprise hooks which are provided on opposing sides of the cover portion to confront one another.

### BRIEF DESCRIPTION OF THE DRAWINGS

In the accompanying drawings, which illustrate an exemplary embodiment of the present invention:

FIG. 1 is schematic view of the components of the switch in connection with a door actuating circuit.

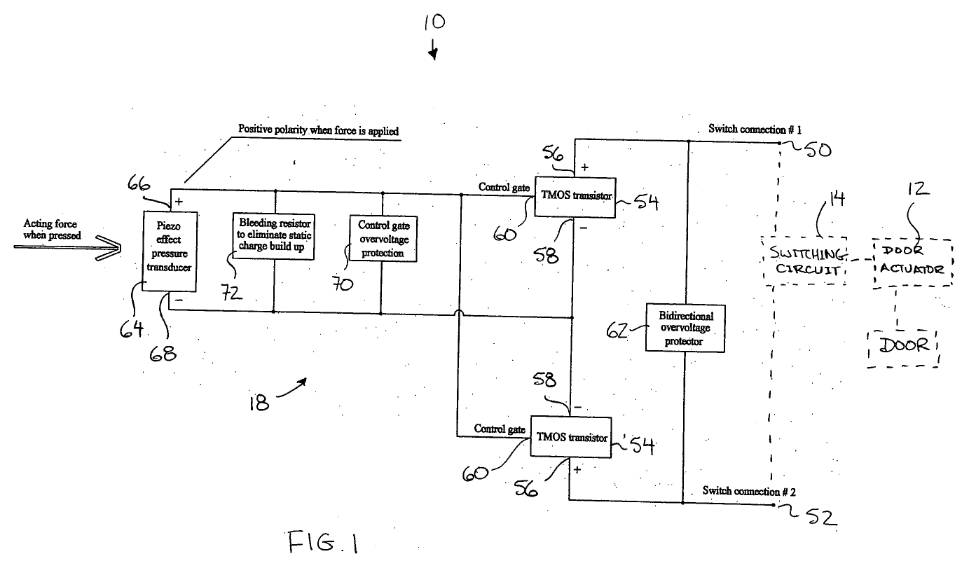

FIG. 2 is a circuit diagram of the switch.

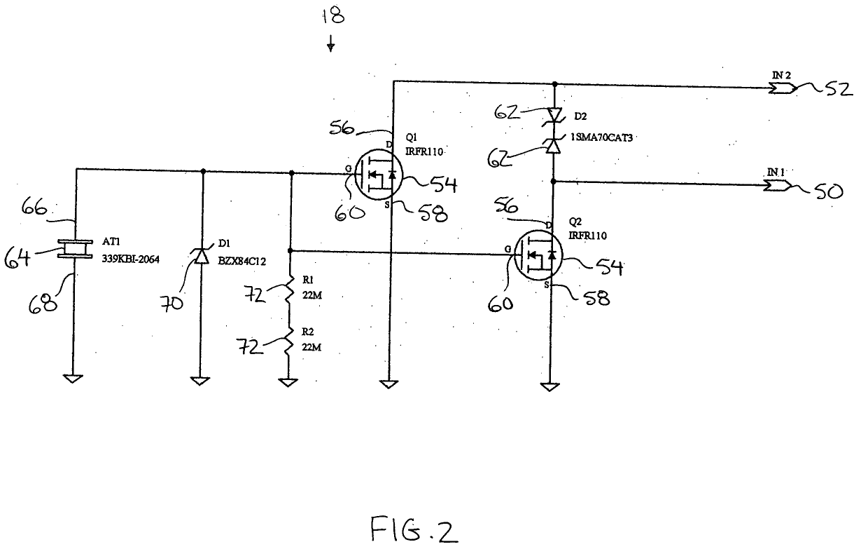

FIG. 3 is a perspective view of the housing locating the electronic assembly of the switch therein.

FIGS. 4A and 4B are side elevational views of the switch in respective closed and open positions.

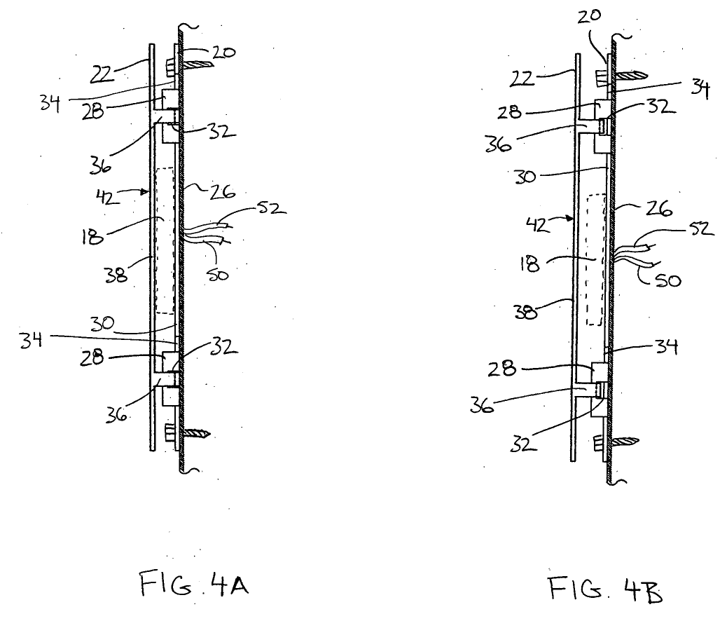

FIGS. 5A through 5E are side elevational views of the cover as it is mounted into place on the mounting plate.

### DETAILED DESCRIPTION

Referring to the accompanying drawings, there is illustrated an electronic switch generally indicated by reference numeral 10. The switch 10 is particularly suited for closing a switching circuit to actuate any one of several known devices. In the illustrated example a door can be opened by a door actuator 12 by means of a door switching circuit 14 which is closed by a wall mounted version of the door switch 10.

The switch 10 includes a housing 16 which houses and protects an electronic assembly 18 therein. The housing includes a mounting plate 20 and a cover plate 22 which can be supported on the mounting plate for relative movement therebetween. The mounting plate 20 is a flat rectangular plate including a pair of mounting apertures 24 formed therein at opposing ends of the plate such that the plate is securable flat against a wall or other supporting surface 26. The mounting apertures 24 include a large aperture portion for receiving the head of a fastener therethrough and a slot portion in a keyhole shape to slidably receive the shaft of a fastener therethrough while retaining the head of the fastener thereon.

The mounting plate 20 includes two pairs of upright mounting flanges 28 spaced apart from one another on opposing sides 30 of the mounting plate respectively and extend upward from the top side 31. Each mounting flange includes a wide retaining slot 32 formed therein which extends from a rear side 33 of the plate to terminate centrally within the mounting flange 28 spaced from the free end of the flange. The retaining slot 32 also extends inwardly into the mounting plate to provide access to the retaining slot from the rear of the mounting plate. An access slot 34 is provided adjacent each mounting flange at equal spacings from respective retaining slots 32. Each access slot 34 is offset from the respective retaining slot 32 in the same direction towards the top end of the plate along respective sides 30 of the plate. Each access slot extends inwardly the same depth and width as the retaining slots 32 extend into the plate.

The cover plate 22 is rectangular and flat in the illustrated embodiment, having similar dimensions as the mounting plate 20. A pair of retainer members 36 are provided at spaced positions along each of two opposing sides 38 of the cover plate so as to be aligned with the retaining slots 32 when the cover plate and mounting plate are aligned. Each retainer member 36 comprises a hook with a depending flange 40 projecting perpendicularly to a cover surface 42 of the cover plate and a hook flange 44 lying parallel to the cover surface 42. The hook flanges 44 are wide and flat and project inwardly so as to confront one another, while being suitably sized to be received within the retaining slots 32. The depending flange 40 is longer than the respective mounting flanges 28 such that the hook flanges 44 are sufficiently spaced from the cover surface 42 of the cover plate that the mounting plate can be received slidably between the opposing pairs of retainer members 36 between the hook flanges 44 and the cover surface 42.

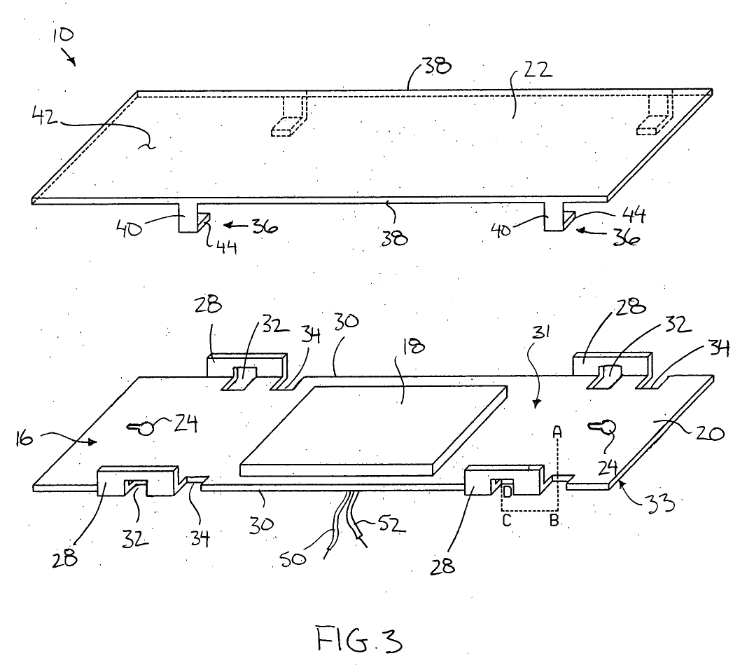

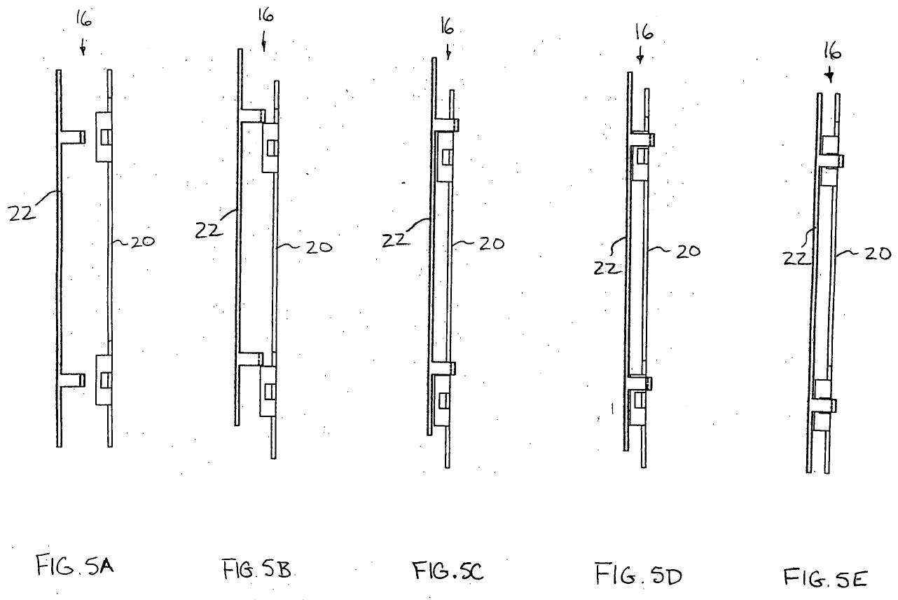

Before installation of the switch on a wall or other supporting surface, the housing is first assembled, typically at the factory where it is manufactured. In order to assemble the housing, the cover plate is attached to the mounting plate by following the steps illustrated in FIGS. 5A through 5E. Accordingly, the retainer members follow a path as illustrated sequentially by reference characters A, B, C and D in FIG. 3 so as to first pass through the access slot 34 from the front side 31 to the rear side 33 of the mounting plate to be subsequently received in the respective retaining slot.

The cover plate is first displaced such that the retainer members are aligned with the access slots 34 in the mounting plate as in FIG. 5B. As the mounting plate and cover plate are brought together in FIG. 5C, the hook flanges are received through the respective access slots to be located rearwardly of the mounting plate. Longitudinal sliding movement of the mounting plate and cover plate are then permitted relative to one another.

From the position of FIG. 5C, the cover plate is slid with the hook flanges 44 along the rear side 33 of the mounting plate, as in FIG. 5D, until the hook flanges align with the retaining slots formed in the upright flanges of the mounting plate, shown in FIG. 5E. Pulling the cover plate and mounting plate apart from one another, from the position of FIG. 5E, results in the retainer members being fully retained within the retaining slots once access through the rear side 33 of the mounting plate is blocked as occurs when the switch is installed on a supporting surface as described further below.

The mounting plate, and cover plate supported thereon, are attached to a supporting surface using suitable fasteners which are first secured to the supporting surface. The mounting plate is first attached with the fasteners not fully tightened so that sufficient space is provided between heads of the fasteners and the supporting surface to receive the thickness of the mounting plate.

The keyhole shape of the mounting apertures 24 in the mounting plate, as described above, permits the heads of the fasteners to be inserted in the mounting apertures through the larger portion to be subsequently received in the slot portion by longitudinal sliding movement of the mounting plate relative to the wall and fasteners. The fasteners preferably comprise a threaded type fastener having a head which is polygonal in cross section for gripping with a suitable wrench and the like.

Further tightening of the fasteners by inserting a wrench at respective ends of the housing between the mounting plate and cover plate permits the mounting plate to be securely tightened directly adjacent the wall. The supporting surface, forming the wall, blocks access to the retaining slots 32 by blocking the rear surface of the mounting plate once the fasteners are fully tightened and the slot portion of the mounting apertures are gripped between the heads of the fasteners and the supporting surface.

The electronic assembly 18 is supported centrally between the plates. The assembly includes first and second switch terminals 50 and 52 respectively. The switch terminals 50 and 52 are connected in series in a switching circuit for opening and closing the circuit. Current between the switching terminals is allowed in both directions when the condition of the switch is closed while current between the terminals is interrupted in both directions in the open condition.

The switch includes two TMOS power transistors 54 which are coupled in an anti-serial configuration between the switch terminals 50 and 52. Each transistor 54 includes a drain terminal 56 a source terminal 58 and a gate terminal 60. The gate terminal 60 comprises a capacitor which controls the current flow properties between the drain and source terminals when a positive voltage is applied to the capacitor forming the gate terminal 60. The TMOS power transistor 54 permits uninterrupted current in one direction in the open condition of the transistor between the drain and source terminals. When the transistor is in a closed condition, a closed circuit is formed between the drain and source terminals. In the opposite direction of the flow, the transistor acts as a diode.

In the anti-serial configuration, each of the transistors is connected at the respective drain and source terminals between the switch terminals 50 and 52 in series with one another but in an opposed configuration such that both the source terminals are directly connected to each other while the drain terminals 56 are connected to the switch terminals respectively. By providing two transistors in anti-serial configuration the switch is effective in alternating current applications as the current is effectively interrupted in both directions due to each transistor acting as a diode limiting current in opposite directions when the transistors are in the open condition. In the closed condition of the transistors current flow is permitted in either direction across the transistors to effectively close the switch.

Parallel to the transistors and in series between the switch terminals, a pair of confronting voltage limiting diodes 62 are provided which act to limit voltage applied across the transistors. The pair of diodes 62 are mounted in series with one another in opposed orientation between the drain terminals of the transistors.

A pressure transducer 64 is provided between the mounting plate and the cover plate to actively close the transistors. The pressure transducer includes a positive terminal 66 connected to both of the gate terminals 60 of the transistors and a negative terminal 68 connected to both of the source terminals of the transistors. Applying pressure to the pressure transducer causes a positive voltage to be applied to the gates of the transistors relative to the source terminals by piezo effect.

Coupled in parallel with the transducer between the gate and source terminals of the transistors is a voltage limiting diode 70 which protects the gates from an over voltage. Also in parallel with the transducer between the gate and source terminals of the transistor are a pair of bleed off resistors in series with one another. The resistors 72 prevent accumulation of a positive charge at the capacitor of the gate terminals so as to prevent erroneous activation of the transistors resulting from static charge build-ups or charges resulting from temperature variation of the pressure transducer and surrounding housing which may apply a stress or pressure on the transducer.

In use, pressure is applied to the cover plate in which the surface thereof comprises a contact area of the switch. The contact area of the cover is movable with the cover relative to the mounting plate so that pressure is applied to the transducer when the contact area is pressed. The pressure transducer causes voltage to be applied to the gate terminal by piezo effect to close the transistors which thus closes the switch to actuate the switching circuit and door actuator to open the door. The length of the retainer members of the cover plate are selected so that the retainer members abut the supporting surface upon which the mounting plate is mounted when a maximum recommended depression of the pressure transducer is reached to limit further deflection or deformation of the transducer which might otherwise cause damage. In an alternative form, limiting of movement between the cover plate and the mounting plate may be accomplished by any suitable stop member formed therebetween.

As noted above with regard to mounting of the cover plate onto the mounting plate, the cover plate travels through the path A-B-C-D to interlock with mounting plate. Once the two plates are interlocked, springs (not shown at the picture) keep the plates apart preventing thus accidental disengagement. By attaching the bottom part to a surface like door jamb, the A-B-C-D path is interrupted between points B and C and the switch can not be disassembled, once installed. Once installed the cover plate, if depressed, moves relative to the mounting plate and exerts defined pressure on pressure transducer. The transducer generates voltage used in turn to change conductivity of a solid state switch.

The number of tabs and slots to interlock is not limited to this particular arrangement, as it may be any number of these, to yield the same result. What is important is the fact that certain points must travel on a particular path which is interrupted once the assembly is attached to a surface, preventing thus any possibility for disassembly.

The purpose of this interlocking mechanism is to provide means as to assemble/disassemble the switch without a need for any tools or any material displacement, like bending or forming. This further facilitates easy inspection, cleaning, repair or replacement of any damaged part.

Apart from the unique mechanical way the switch is assembled, the actual switching is accomplished by electronic means, so that there is no material wear or resulting limited number of ON/OFF cycles as is typically associated with mechanical door access switches. The switching utilizes two TMOS transistors in anti-serial configuration, with their gate terminals connected together. To change the state of a TMOS transistor from nonconductive to conductive, the control electrode, the gate terminal, has to have certain potential relative to the common electrode called the source terminal. Depending on the TMOS transistor construction this potential is typically +/−3 to +/−8 volts. An important property of the gate terminal is that no current is needed to maintain the TMOS transistor in its ON state, as the gate terminal is basically a capacitor, therefore only potential is needed to change the conductivity. This potential is generated by the pressure transducer utilizing the piezo effect. In addition to the above, the actual circuit has high value bleedoff resistor between the gate and source terminals to prevent any static electricity build up. Also a Zener diode limits the maximum gate voltage to such a value as to not exceed the TMOS transistor specifications.

While one embodiment of the present invention has been described in the foregoing, it is to be understood that other embodiments are possible within the scope of the invention. For example, the cover plate may be of various shapes including circular profiles or plates having a curved or convex surface in which size of the plate is preferably equal to or greater than the mounting plate for concealing the mounting plate or at least the fasteners thereof. The invention is to be considered limited solely by the scope of the appended claims.

1. A switch comprising:
a pair of switch terminals;
a transistor having a drain terminal and a source terminal connecting the transistor in series between the switch terminals whereby current flow is permitted between the switch terminals in both directions when the transistor is closed;
a housing having a movable contact area; and
a pressure transducer located within the housing in communication with the contact area;
the transistor including a gate terminal connected to the pressure transducer to close the transistor when pressure is applied to the pressure transducer.

2. The switch according to claim 1 wherein the gate terminal is a capacitor.

3. The switch according to claim 2 wherein there is provided a bleed-off resistor coupled to the gate terminal.

4. The switch according to claim 2 wherein the transistor comprises a TMOS power transistor.

5. The switch according to claim 2 wherein there is provided a pair of transistors connected at respective source and drain terminals in an anti-serial configuration with the switch terminals.

6. The switch according to claim 5 wherein there is provided a pair of voltage limiting diodes coupled together in an opposed configuration in parallel with the pair of transistors between the switch terminals to limit maximum voltage applied across the transistors.

7. The switch according to claim 1 wherein there is provided stop means limiting maximum deflection of the contact area of the housing.

8. The switch according to claim 1 wherein there is provided a voltage limiting diode coupled between the gate terminal and the source terminal of the transistor to limit maximum voltage applied to the gate terminal.

9. The switch according to claim 1 wherein the housing includes a mounting plate for mounting on a suitable supporting surface and wherein the movable contact area comprises a cover plate supported on the mounting plate for relative movement therebetween.

10. The switch according to claim 9 wherein there is provided stop means limiting maximum deflection of the cover plate relative to the mounting plate.

11. The switch according to claim 9 wherein the mounting plate includes mounting apertures formed therein for receiving fasteners to mount the mounting plate to a supporting surface, and wherein the cover plate conceals the mounting apertures when supported on the mounting plate.

12. The switch according to claim 9 wherein the cover plate includes a plurality of retainer members selectively received in co-operating slots in the mounting plate accessible through a rear of the mounting plate such that access to the slots is blocked to retain the cover plate on the mounting plate when the mounting plate is mounted on a supporting surface.

13. The switch according to claim 12 wherein the retainer members each comprise a hook having a free end portion which is flat lying generally parallel to a front surface of the cover plate.

14. The switch according to claim 12 wherein the retainer members comprise hooks which are provided on opposing sides of the cover portion to confront one another.

15. A switch comprising:
a pair of switch terminals;
a transistor having a drain terminal and a source terminal connecting the transistor between the switch terminals whereby current flow is permitted between the switch terminals when the transistor is closed;
a housing including a mounting plate for mounting on a suitable supporting surface and a cover plate supported on the mounting plate for relative movement therebetween; and
a pressure transducer located between the mounting plate and the cover plate of the housing;
the transistor including a gate terminal connected to the pressure transducer to close the transistor when pressure is applied to the pressure transducer; the cover plate including a plurality of retainer members selectively received in co-operating slots in the mounting plate, accessible through a rear of the mounting plate such that access to the slots is blocked to retain the cover plate on the mounting plate when the mounting plate is mounted on a supporting surface.

16. The switch according to claim 15 wherein the retainer members each comprise a hook having a free end portion which is flat lying generally parallel to a front surface of the cover plate.

17. The switch according to claim 15 wherein the retainer members comprise hooks which are provided on opposing sides of the cover portion to confront one another.

18. A method of actuating an automatic door, the method comprising:
providing a door actuator to open the door responsive to condition of a door switching circuit;
providing a door switch comprising a pressure transducer and a transistor having a drain terminal, a source terminal and a gate terminal connected to the pressure transducer;
connecting the drain terminal and the source terminal in series with the door switching circuit; and
applying pressure to the pressure transducer to close the transistor and actuate the door actuator via the door switching circuit.

19. The method according to claim 18 wherein the gate terminal comprises a capacitor.

20. The method according to claim 18 wherein the door switch comprises a pair of transistors connected at respective source and drain terminals in an anti-serial configuration with the door switching circuit.
